(19) United States
(12) Patent Application Publication
(10) Pub. No.: US 2002/0055962 A1
(43) Pub. Date: May 9, 2002

(54) Automatically solving equations in finite fields

(76) Inventor: Richard Schroeppel, Woodland Hills, UT (US)

Correspondence Address: RICHARD SCHROEPPEL, 500 S. MAPLE DRIVE, WOODLAND HILLS, UT, 84653, US

(21) Appl. No.: 09/834,363

(22) Filed: Apr. 12, 2001

Related U.S. Application Data
(63) Continuation-in-part of application No. 09/518,389, filed on Mar. 3, 2000.
(63) Continuation-in-part of application No. 09/710,987, filed on Nov. 8, 2000.
(60) Provisional application No. 60/165,202, filed on Nov. 12, 1999.
(60) Provisional application No. 60/196,696, filed on Apr. 13, 2000.

(51) Int. Cl. G06F 7/52; G06F 7/00

(52) U.S. Cl. 708/650; 708/491; 708/492

(57) ABSTRACT

A new method and apparatus for speeding up cryptographic calculations relies on faster methods for automatically calculating the solutions of certain equations. This includes a faster method for modular division, and a faster method for solving quadratic equations in characteristic 2 fields. The improvement speeds up key exchange, encryption, and digital signatures.

### RELATED APPLICATIONS

This application claims the benefit of U.S. Provisional Application Serial No. 60/165,202, filed Nov. 12, 1999 and entitled METHOD AND APPARATUS FOR ELLIPTIC CURVE POINT AMBIGUITY RESOLUTION, is a continuation-in-part of co-pending patent application Ser. No. 09/518,389, filed Mar. 3, 2000 and entitled CRYPTOGRAPHIC ELLIPTIC CURVE APPARATUS AND METHOD, also claims the benefit of U.S. Provisional Application Serial No. 60/196,696 filed Apr. 13, 2000 and entitled AUTOMATICALLY SOLVING EQUATIONS IN FINITE FIELDS, and is a continuation-in-part of U.S. patent application Ser. No. 09/710,987 filed Nov. 8, 2000 and entitled METHOD AND APPARATUS FOR ELLIPTIC CURVE POINT AMBIGUITY RESOLUTION. The foregoing applications are hereby incorporated by reference.

### BACKGROUND

1. The Field of the Invention

This invention relates to cryptography and, more particularly, to novel systems and methods for increasing the speed of cryptographic computations by computers.

2 The Background Art

The science of cryptography has existed since ancient times. In recent years, cryptography has been used in special purpose software programs for a variety of purposes, such as hiding underlying contents, limiting access, inhibiting reverse engineering, authenticating sources, limiting unauthorized use, and the like.

### Cryptographic Processes

Modern Cryptography protects data transmitted over a network or stored in computer systems. Two principle objectives of cryptography include (1) secrecy, e.g., to prevent the unauthorized disclosure of data, and (2) integrity (or authenticity), e.g., to prevent the unauthorized modification of data. Encryption is the process of disguising plaintext data in such a way as to hide its contents, and the encrypted result is known as ciphertext. The process of turning ciphertext back into plaintext is called decryption.

A cryptographic algorithm, also known as a cipher, is a computational function used to perform encryption and/or decryption. Both encryption and decryption are controlled by one or more cryptographic keys. In modern cryptography, all of the security of cryptographic algorithms is based on the key(s) and does not require keeping the details of the cryptographic algorithms secret.

There are two general types of key-based cryptographic algorithms: symmetric and public-key. In symmetric algorithms, the encryption key can be calculated from the decryption key and vice versa. Typically, these keys are the same. As such, a sender and a receiver agree on the keys (a shared secret) before they can protect their communications using encryption. The security of the algorithms rests in the key, and divulging the key allows anyone to encrypt data or messages with it.

In public-key algorithms (also called asymmetric algorithms), the keys used for encryption and decryption differ in such a way that at least one key is computationally infeasible to determine from the other. To insure secrecy of data or communications, only the decryption key need be kept private, and the encryption key can thus be made public without danger of encrypted data being decipherable by anyone other than the holder of the private decryption key.

Conversely, to ensure integrity of data or communications, only the encryption key need be kept private, and a holder of a publicly-exposed decryption key can be assured that any ciphertext that decrypts into meaningful plaintext using this key could only have been encrypted by the holder of the corresponding private key, thus precluding any tampering or corruption of the ciphertext after its encryption.

A private key and a public key may be thought of as functionally reciprocal. Thus, whatever a possessor of one key of a key pair can do, a possessor of the other key of the key pair can undo. Accordingly, secret information may be communicated without an exchange of keys.

An asymmetric algorithm assumes that public keys are well publicized in an integrity-secure manner. A sender can then know that the public key of the receiver is valid and not tampered with. One way to ensure integrity of data packets is to run data through a cryptographic algorithm. A cryptographic hash algorithm may encrypt and compress selected data. Various cryptographic hash algorithms are known, such as the Secure Hash Algorithm (SHA) and Message Digest 5 (MD5).

A certificate is a data structure associated with assurance of integrity and/or privacy of encrypted data. A certificate binds the identity of a holder to a public key of that holder, and may be signed by a certification authority (CA). In a public key infrastructure (PKI), a hierarchy of certification authorities may be provided, each level vouching for the authenticity of the public keys of subordinate levels.

A certificate may contain data regarding the identity of the entity being certified, the key held (typically a public key), the identity (typically self-authenticating) of the certifying authority issuing the certificate to the holder, and a digital signature protecting the integrity of the certificate itself. A digital signature may typically be based on the private key of the certifying authority issuing the certificate to the holder. Thus, any entity to whom the certificate is asserted may verify the signature corresponding to the private key of the certifying authority.

In general, a signature of a certifying authority is a digital signature. The digital signature associated with a certificate enables a holder of the certificate, and one to whom the certificate is asserted as authority of the holder, to use the signature of the certifying authority to verify that nothing in the certificate has been modified. This verification is accomplished using the certificate authority's public key, thus providing a means for verifying the integrity and authenticity of the certificate and of the public key in the certificate.

Various cryptographic techniques rely on elliptic curves. Code and documentiation for the use of elliptic curves in cryptography are available. For example, standard references, including certain algebra texts discussing Galois Fields, sometimes called “finite fields”, are available in the art.

One reason for interest in acceleration of elliptic curve processing is the increasing size of cryptographic keys. Mathematical calculations often increase geometrically with the size of the keys. Accordingly, if the speed of elliptic curve processing can be increased, less processing time is required for more secure, longer cryptographic keys. Thus, what is needed is methods and apparatus for accelerating computations associated with creating, weaving, and processing of cryptographic keys.

Public key cryptography makes extensive use of modular arithmetic functions and concepts, especially powers. Computing Aˆ B (mod C) is a staple operation. Hereinafter, the caret ˆ means exponentiation (i.e., A to the power B). Generally, the modular arithmetic can be replaced with operations in an arbitrary group, and elliptic curve groups have been found to be useful. Instead of (mod C), an elliptic curve group G can be used. The elements of G are called points. The multiplication operation (mod C) is replaced by addition of group elements (points), and the exponentiation Aˆ B is replaced by adding B copies of the point A.

### BRIEF SUMMARY AND OBJECTS OF THE INVENTION

In view of the foregoing, it is a primary object of the present invention to provide an apparatus and method comprising an elliptic curve, point modification system.

Consistent with the foregoing object, and in accordance with the invention as embodied and broadly described herein, an apparatus and method are disclosed in certain embodiments of the present invention as including a method and apparatus for operating a cryptographic engine supporting a key generation module. The key generation module creates key pairs for encryption of substantive content to be shared between two users over a secured or unsecured communication link.

In certain embodiments an apparatus and method in accordance with the present invention may include an apparatus and method useful for communications, for example over an insecure channel such as a public network. It is an object of the invention to provide an apparatus and method that may be used for Key Exchange, and for Signing and Verifying messages. It is a further object of the invention to provide an apparatus and method that is useful in electronic commerce, specifically without limitation for distributing authenticated public keys over the Internet and for encryption generally.

It is another object of the present invention to provide an apparatus and method for efficient and rapid authentication of physical documents, such as airplane tickets, postage stamps, bonds, and the like. The present invention may also be used as part of an electronic cash system.

Most public key cryptography operations such as key exchange, digital signatures, encryption, and entity authentication, can be implemented very efficiently using elliptic curve arithmetic. It is an object of this invention to make elliptic curve arithmetic faster, and thereby improve the public key operations. It is yet another object of the invention to be useful for faster elliptic-curve key exchange, for faster elliptic-curve ElGamal encryption, for faster elliptic-curve Digital Signatures, and for faster MQV authentication (see IEEE draft standard P1363). It is also an object of the invention to be generally useful wherever computations with elliptic curves are used. The improvement works with any field-element representation, including polynomial basis representation, normal basis representation, and field-tower representation.

The invention is described as a set of formulas which are implemented as a computer program. The same computations can also be carried out very efficiently in purpose-built hardware devices, or in semi-custom logic, for example, smart-cards or FPGA circuits, or as firmware controlling hardware, or as a combination of these elements.

A principal feature provided by the apparatus and method in accordance with the invention includes a point modification algorithm that manipulates points of an elliptic curve method. The point modification algorithm may be used in generating a key using a selected elliptic curve method, which may be used to encrypt substantive content using the key. The point modification algorithm may be employed using any one or a combination of point addition, point subtraction, point fractioning, point multiplying, rotating, and negative point modification.

In one aspect of the invention, the point fractioning may be selected from integral point fractioning, corresponding to a denominator that is an integral number, and point multiplying may be selected from integral multiplication, imaginary multiplication, and complex multiplication. In selected embodiments, the point modification algorithm may be dynamically selected during use in lieu of specifying the modification operation in advance.

In another aspect of the invention, a selected property may be used to select a point on which to execute the point modification algorithm. The selection property may include without limitation membership of the point in a selected subgroup. The selection property may include reliance on a bit mask of coordinates corresponding to points in a subgroup.

A point may be selected and pre-modified by a modification operation that compensates for some of the processing steps. A point may be selected by testing whether a halving procedure can be executed on the point an arbitrary number of times selected by a user. The modification process may also include determining which of a selected number of points is to be used. The foregoing point modification processes may be repeated with a second point, which is selected by either a deterministic process or a random process.

In yet another aspect of the invention, substantive content may be sent by a sender and received by a receiver. The sender may use a modification process for encryption that is separate and distinct from the modification that the receiver uses for decryption. The key may be a symmetric key configured to be shared by two or more parties, a decryption code for processing an encrypted signal, a digital signature, an asymmetric key, or an authentication. The modification operation may also include the step of selecting a point from either a hyperelliptic, an algebraic curve, or an abelian variety.

In a further aspect of the invention, the modification process may be the halving of a point. The point to be halved may be represented in a cartesian space or the point may exist in a mapped cartesian space having a cartesian representation. The halving operation may include only a single multiplication per halving operation or multiple multiplications. The selected point may be by a cartesian tuple and halving may be accomplished using no more than two field multiplications. The halving operation may be negative halving including without limitation computation of a minus one-half multiple. The modification process may also include computing a fractional multiple of a point represented as a proper fraction, an improper fraction, or a complex fractional multiple.

Another feature provided by an apparatus and method in accordance with the invention includes a point modification algorithm as part of an elliptic curve module within a key generation module for creating and processing keys. Hash functions may be used to further process ephemeral secrets or ephemeral keys that may be used for transactions, sessions, or other comparatively short time increments of communication. The modification algorithm preferably employs one or some combination of point addition, point subtraction, point fractioning, point multiplying, rotating, and negative point modification.

The keys generated by the key generation module may be configured to be processable by an encryption system for divulging independently to two independent parties a secret to be shared by the two independent parties. In various embodiments, a point modification algorithm is provided to reduce the operation count of a cryptographic process.

The present invention may also be embodied as an article storing an encryption engine for operating on keys configured to encrypt substantive content representing information that includes a key generation module for operating on the keys and a point modification algorithm for calculating points related to the key. The point modification algorithm may employ one or more of point addition, point subtraction, point fractioning, point multiplying, rotating, and negative point modification.

In one aspect of the invention, the point halving module may include a register for storing an ordered pair of variables selected to be operated on for executing point halving. The ordered pairs may represent a set of coordinates corresponding to a point on an elliptic curve.

It is another aspect of the invention to be generally useful wherever division is required in modular arithmetic systems, or finite fields, or rings. This includes without limitation cryptographic applications that are not based on elliptic curves, such as, for example, NISTs Digital Signature Algorithm.

The above objects may be met by one or more embodiments of an apparatus and method in accordance with the invention. Likewise, one or more embodiments of an apparatus and method in accordance with the invention may provide the desirable features as described.

### BRIEF DESCRIPTIONS OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of an apparatus suitable for implementing a method and system in accordance with the invention for an individual user, or multiple users communicating over a network or internetwork;

FIG. 2 is a schematic block diagram of select modules that may be hosted in a memory device operating on a computer of a user in accordance with the invention;

FIG. 3 is a schematic block diagram of a key generation module that mey implement certain aspects of a method and system in accordance with the invention;

FIG. 4 is a schematic block diagram opf a process for encryption using a method in accordance with the invention;

FIG. 5 is a schematic block diagram of a process in accordance with the invention including generation of keys, use of the keys for encryption, and decryption of the content of a message; and

FIG. 6 is a schematic block diagram of an abbreviated method of authentication in accordance with the invention.

### DETAILED DESCRIPTION OF THE PREFERRED EMBODIMENTS

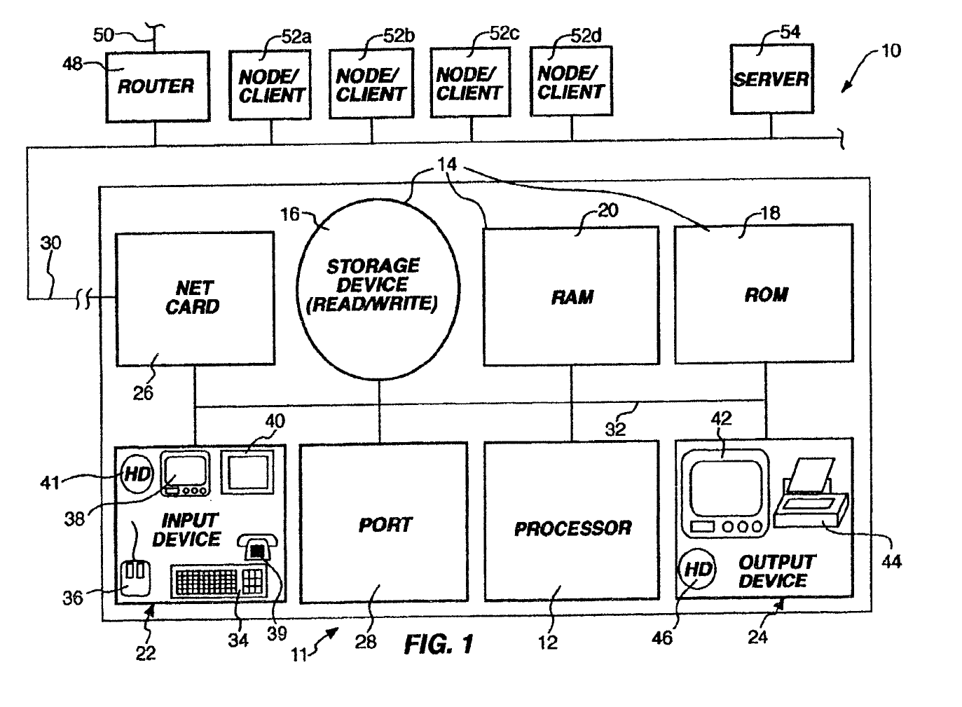

It will be readily understood that the components of the present invention, as generally described and illustrated in the Figures herein, could be arranged in a wide variety of different configurations. Thus, the following more detailed description of the embodiments of the system and method of the present invention, as represented in FIGS. 1 through 6, is not intended to limit the scope of the invention, as claimed, but it is merely representative of certain presently preferred embodiments of the invention.

The presently preferred embodiments of the invention will be best understood be reference to the drawings, wherein like parts are designated by like numerals throughout. Reference numerals having trailing letters may be used to represent specific individual items (e.g. instantiations) of a generic item associated with the reference numeral. Thus, a number 156a, for example, may be the same generic item as number 156f, but may result from a different version, instantiation, or the like. Any or all such items may be referred to by the reference numeral 156.

Referring to FIG. 1, an apparatus 10 may implement the invention on one or more nodes 11, (client 11, computer 11) containing a processor 12 or CPU 12. All components may exist in a single node 11 or may exist in multiple nodes 11, 52 remote from one another. The CPU 12 may be operably connected to a memory device 14. A memory device 14 may include one or more devices such as a hard drive or non-volatile storage device 16, a read-only memory 18 (ROM) and a random access (and usually volatile) memory 20 (RAM).

The apparatus 10 may include an input device 22 for receiving inputs from a user or another device. Similarly, an output device 24 may be provided within the node 11, or accessible within the apparatus 10. A network card 26 (interface card) or port 28 may be provided for connecting to outside devices, such as the network 30.

Internally, a bus 32 may operably interconnect the processor 12, memory devices 14, input devices 22, output devices 24, network card 26 and port 28. The bus 32 may be thought of as a data carrier. As such, the bus 32 may be embodied in numerous configurations. Wire, fiber optic line, wireless electromagnetic communications by visible light, infrared, and radio frequencies may likewise be implemented a appropriate for the bus 32 and the network 30.

Input devices 22 may include one or more physical embodiments. For example, a keyboard 34 may be used for interaction with the user, as may a mouse 36 or similar pointing device. A touch screen 38, a telephone 39, or simply a telephone line 39, may be used for communication with other devices, users, or the like. Similarly, a scanner 40 may be used to receive graphical inputs which may or may not be translated to other character formats. A memory device 41 of any type (e.g. hard drive, floppy, etc.) may be used as an input device, whether resident within the node 11 or some other node 52 on the network 30, or from another network 50.

Output devices 24 may likewise include one or more physical hardware units. For example, in general, the port 28 may be used to accept inputs and send outputs from the node 11. A monitor 42 may provide inputs to a user for feedback during a process, or for assisting two-way communication between the processor 12 and a user. A printer 44 or a hard drive 46 may be used for outputting information as output devices 24.

In general, a network 30 to which a node 11 connects may, in turn, be connected through a router 48 to another network 50. In general, two nodes 11, 52 may be on a network 30, adjoining networks 30, 50, or may be separated by multiple routers 48 and multiple networks 50 as individual nodes 11, 52 on an internetwork. The individual nodes 52 (e.g. 11, 52, 54) may have various communication capabilities.

In certain embodiments, a minimum of logical capability may be available in any node 52. Note that any of the individual nodes 11, 52, 54 may be referred to, as may all together, as a node 11 or a node 52. Each may contain a processor 12 with more or less of the other components 14-44.

A network 30 may include one or more servers 54. Servers may be used to manage, store, communicate, transfer, access, update, and the like, any practical number of files, databases, or the like, for other nodes 52 on a network 30. Typically, a server 54 may be accessed by all nodes 11, 52 on a network 30. Nevertheless, other special functions, including communications, applications, directory services, and the like may be implemented by an individual server 54 or multiple servers 54. A node 11 may be a server 54.

In general, a node 11 may need to communicate over a network 30 with a server 54, a router 48, or nodes 52 or server 54. Similarly, a node 11 may need to communicate over another network (50) in an internetwork connection with some remote node 52. Likewise, individual components 12-46 may need to communicate data with one another. A communication link may exist, in general, between any pair of devices. The process and method of the invention may be performed on the hardware structure illustrated in FIG. 1.

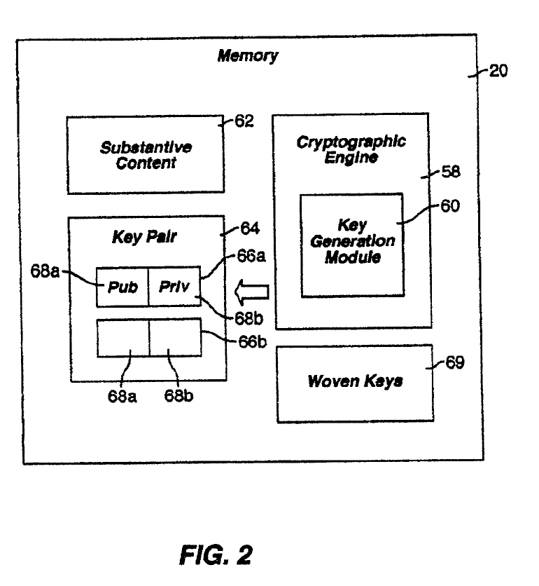

Referring to FIG. 2, a memory device 20 in an apparatus 10, and more particularly in an individual computer 11, may include a cryptographic engine 58 for creating, manipulating, processing, using, and otherwise operating on cryptographic keys. Cryptographic keys are known in the art. A key generation module 60 may be responsible for creating keys that may be used to encrypt substantive content 62 for one of a multitude of purposes. As discussed above, the substantive content 62 may be used for various functionalities, including transmission of the substantive content 62 between users.

In general, a key generation module 60 may support local and remote repositories 64 of key pairs 66. A key pair 66 may involve a public key 68a and a private key 68b. In alternative embodiments, a particular key pair 66a may include symmetric keys 68a, 68b. However, in current strong cryptography, the individual keys 68a, 68b are a public/private pair used as described above for preparing and processing information to be sent and received.

In certain embodiments, keys 68a, 68b from various users may be mixed and matched between public and private keys in order to prepare woven keys 69 that are used by senders and receivers on opposite ends of a communication link to securely hide, authenticate, sign, etc., substantive content 62 that is being exchanged.

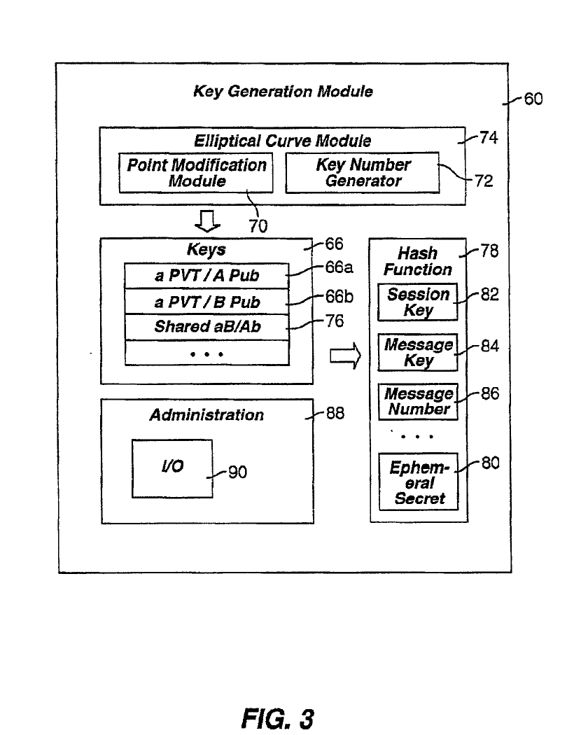

Referring to FIG. 3, the key generation module 60 may include an elliptic curve module 74 in accordance with the invention. In one presently preferred embodiment, a point modification module 70 may operate in accordance with the algorithms described hereinafter, to generate the keys 68 provided by the key generation module 60. The point modification module 70 may employ one or more of point addition, point subtraction, point fractioning, point multiplying, rotating, negative point modification, alone or in combination, for modifying points. A key number generator 72 may include an executable of basic simplicity or considerable sophistication in order to create keys having a desired level of security. Levels of security are typically defined in terms of the algorithms executed by key number generators 72, and equivalent processing 72 executed upon receipt of encrypted information.

Key pairs 66, such as the public/private pairs 66a, 66b or the shared, woven keys 76, may be processed by a hash function 78. The hash function 78 may typically operate on an ephemeral secret 80. An ephemeral secret 80 may be embodied in a session key 82 shared by two users over a communication link during a “session” period of time defined by the users or by their respective computers. Similarly, for a single communication of substantive content 62, an individual message key 84 may be created and relied upon. In one embodiment, a message key 84 may be embodied simply as a message number 86 corresponding to a time, random number, or some combination of numbers associated by a user with a single message.

Practicalities of computation associated with cryptography require that some number of administration modules 88 provide support for the key generation module 60. For example, in one embodiment, input/output drivers 90 may be provided. Likewise, the input/output systems 90 may provide the wrapping, pre-processing, post-processing, maintenance, verification, and the like associated with creating, distributing, using, and management of the keys 68.

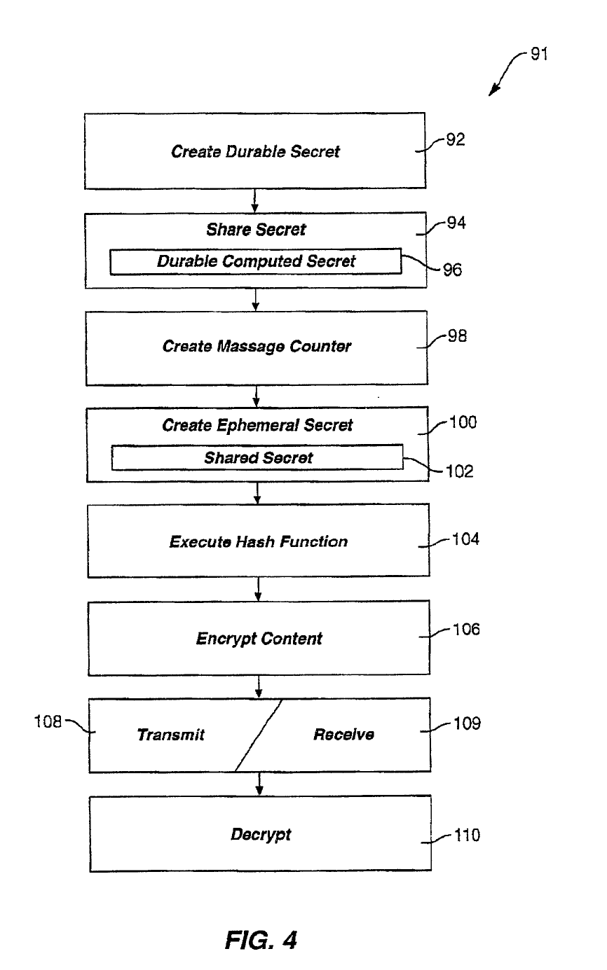

Referring to FIG. 4, a method 91 for using the apparatus and systems in accordance with the invention may involve creating 92 a durable secret. A durable secret may refer to a shared key (whether symmetric or asymmetric) that will be relied upon over an extensive period of time, such as a year.

Sharing 94 the durable secret involves an exchange, distribution, or the like of a durable secret 96 or computed secret 96 sufficiently strong to be reliable over an extensive period of time involving numerous communications between users. In order to initiate use, creating 98 a message counter may occur during individual transactions, in preparation for a short sequence of transactions, or for some other time period that is comparatively short, spanning a transaction, a few transactions, or the like.

In general, creating the message counter 98 will be used for creating 100 an ephemeral secret 80. For example, the shared secret 102 may have a duration of a single message, or a single computer session, or the like. Thus, the shared secret 102 may be an ephemeral secret 80 of a comparatively short length or suitable for processing by a comparatively simple process. However, creating 100 an ephemeral secret 80, such as the shared secret 102 may be computationally very intensive due to both the manipulations of numbers required as well as the frequency with which such creating 100 is done.

Executing 104 a hash function may be done as known in the art or as described in the art. Hashing 104 provides verification to both machines and users that no message modification, whether intentional or unintentional (e.g., modification simply due to a computer glitch), has occurred. Hashing is also used to operate on the woven key 69 and the message number 86 to create an ephemeral symmetric key.

Thereafter, encrypting 106 substantive content 62 may be followed by a transmission 108 and corresponding receipt 109 of the substantive content 62. The substantive content 62 may have been prepared with a cryptographic system. Note that the substantive content 62 may merely be a signature on a document in the clear. Alternatively, substantive content 62 may have been encrypted itself and wrapped, as well as being signed, authenticated, verified, and the like.

Thus, cryptographic key generation modules 60, or more properly, key management modules 60, may manage one or more keys. Moreover, those one or more keys may be incoming, outgoing, or the like. Also, those keys 68 may be used on substantive content 62, that is destined to be outgoing, incoming, or bith.

Decrypting 110 returns substantive content 62 into the clear. Decrypting 110 may be more complex, exactly the same complexity, or less complex than an encrypting process 106. Nevertheless, in certain embodiments, encrypting 106 and decrypting 110 are substantially mirror images of one another.

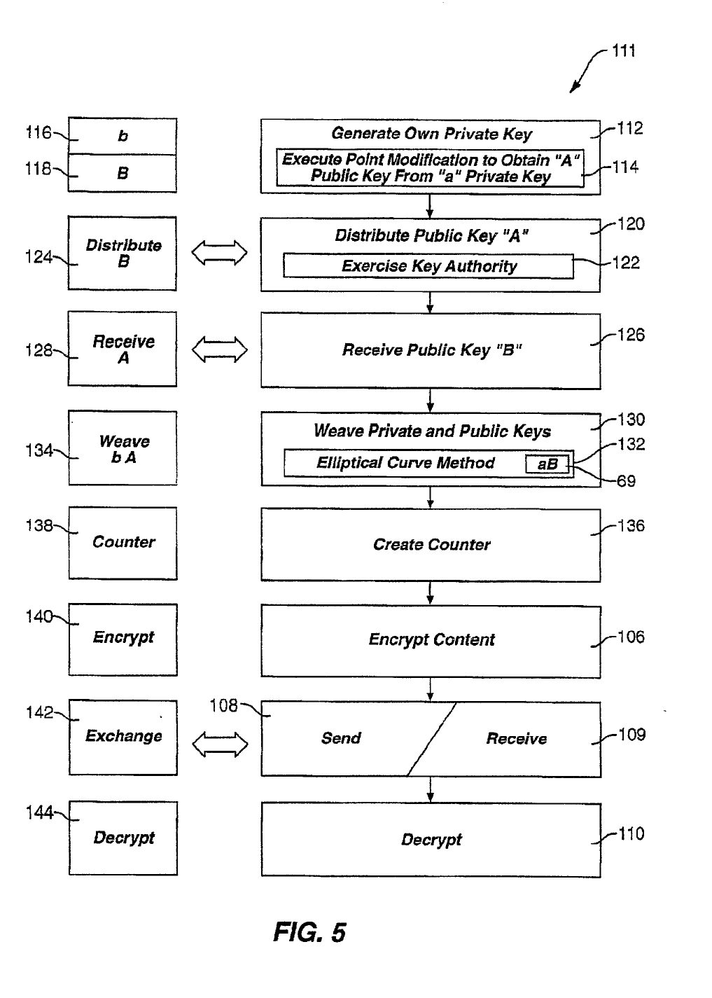

Referring to FIG. 5, a method 111 in accordance with the invention may include generating 112 a private key 68b. Generating 112 keys may rely on executing 114 a point modification method, which may include without limitation a point halving method, in order to obtain an initial public key based on a corresponding private key. At another location, a different user who will eventually correspond to an initial user, may also generate 116 a public key from a private key relying on point modification 118, which may be a point halving 118. At this stage, the generation processes 112, 116 are performed apart.

Distributing 120 a public key 68a may require authorization or other exercise 122 of a key authority. In other words, one may execute 122 or exercise 122 a key authority, where the key authority is an actual entity or where the authority represents the authorization owned by an entity. Accordingly, in a corresponding process, a distribution 124 of a key that will end up being distributed to a first user from a second user may be completed.

Thus, a user “A” may distribute a public key “A” to a user “B”. Similarly, a user “B” may distribute a public key “B” to a remote user “A”. A user may receive 126 a public key from another user. Accordingly, a corresponding partner in communication may receive 28a a first user's public key.

In certain embodiments, weaving one's own private key with a received public key may rely on an elliptic curve method 132. The elliptic curve method 132 results in a woven key 69. Similarly, weaving 134 results in the same woven key for a remote user. Creating 136, 138 a counter enables an encryption 106, 140 of substantive content 62 being shared between a user “A” and a user “B”.

Exactly who performs the encrypting 106, 140 depends upon the directionality of a message, authentication, or other substantive content 62. Appropriately, a transmission 108 and reception 109, or a send 108 and a receive 109 will represent a particular user. Similarly an exchange 142 (which may be a send 108 or a receive 109) represents activities at a remote user.

Accordingly, decrypting 110, 144 provides the substantive content 62 in the clear. Of course, the substantive content 62 may simply be knowledge provided by transmission of signatures, authentications, and the like. Each of the processes of generating 112 distributing 120, weaving 130, and the like may involve the processing of large numerical keys. The use of a method and apparatus in accordance with the invention may be more time-consuming or time-saving depending on the frequency and complexity of any particular key manipulation. Similarly, encrypting 106, 140 and decrypting 110, 144 may use methods in accordance with the invention, depending on the need for security, the complexity, the frequency, an so forth.

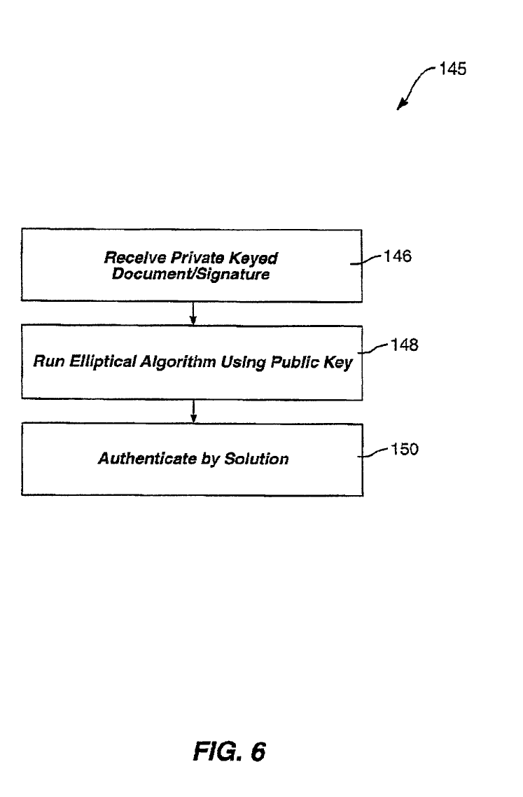

Referring to FIG. 6, an embodiment of a method 145 may be simplified to receiving 146 a privately keyed document. A document may actually be a signature. Nevertheless, receiving 146 implies keyed (encrypted) processing.

Next, running 148 an elliptic algorithm using public key processed information prepared with a private key by an originator. Authenticating 150 may represent a successful calculation of a solution to an equation or set of equations using the keys 68 or a key 68.

Most public key cryptography operations such as key exchange, digital signatures, encryption, and entity authentication, can be implemented very efficiently using elliptic curve arithmetic. An apparatus and method in accordance with the invention may make elliptic curve arithmetic faster, and thereby improve the public key operations. Faster elliptic-curve key exchange, faster elliptic-curve ElGamal encryption, for faster elliptic-curve Digital Signatures, and for faster MQV authentication (see IEEE draft standard P1363), are most useful, although the methods herein may be helpful wherever computations with elliptic curves are used.

Such a method works with any field-element representation, so long as a reasonably efficient reciprocal operation is available. This includes polynomial basis representation, normal basis representation, and field-tower representation. A set of formulas in accordance with the invention may be implemented in a computer program, such as the point modification module 70. In certain presently preferred embodiments, the point modification module 70 is configured to generate a key using a point modification algorithm, as described immediately below. The same computations can also be carried out very efficiently in firmware, dedicated hardware devices, or in semi-custom logic, such as, for example, smart-cards or FPGA circuits.

### Details of The Improvements

The present invention supplies improvements for speeding up two operations in finite fields, in modular arithmetic, and some polynomial rings. The improvements apply to both hardware and software. The first operation discussed is (exact) Division. The second operation is the solution of certain quadratic equations. Both operations are important in public-key cryptography and other places.

### Division

The (Exact) Division operation is used in the DSA algorithm for computing digital signatures and for verifying those signatures. It is used extensively in elliptic-curve cryptography, in characteristic 2 fields, in (mod P) fields; and in other fields. It is also used in other non-field structures such as rings. Division is used in many other cryptographic procedures and methods.

In several mathematical systems, such as modular arithmetic, and finite fields or rings, it's often necessary to compute a solution Q to an equation D*Q=N. The solution is written N/D. It represents the exact quotient of the numerator N divided by the denominator D, with no remainder. For example, in modulo 7 arithmetic, we might have D=3 and N=5. Then Q=N/D=5/3=4. [Check: 3*4=5 in mod 7 arithmetic.] One way to do this calculation is to use a reciprocal algorithm, which solves a special case of the equation with N=1. The solution is called the reciprocal of D, and is written as 1/D or Dˆ −1. The equation with general N is solved by multiplying N times the reciprocal, giving Q=N*(1/D). Continuing the example, the reciprocal of D=3 in mod 7 arithmetic is 5, because 3*5=1, so 1/3=3ˆ −1=5. The quotient 5/3 is Q=5*(1/3)=5*5=4.

Reciprocals may be computed with various algorithms, such as Extended-GCD (see Knuth's book “The Art of Computer Programming”, especially volume 2), or the Almost Inverse Algorithm (see Schroeppel et. al., in Proceedings of Crypto '95), or with Kaliski's “Montogmery Inverse” (see Kaliski, “The Montgomery Inverse and Its Applications”, IEEE Transactions on Computers, August 1995), or with my blend of Almost-Inverse and Montgomery-Inverse, as used in the computer program JAVA.

The Blend Algorithm to partially compute the reciprocal of D (mod M) (D and M are positive relatively prime integers, and M is odd) is

Initialize B=1, C=0, F=D, G=M, K=0.

Loop:

While F is even, {Do F=F/2, C=2C, K=K+1}.

If F=1, return B and K.

If F<G, exchange F with G and exchange B with C.

If F=G (mod 4), {F=F−G, B=B−C}

otherwise, {F=F+G, B=B+C}

Goto Loop.

As with the Almost-Inverse Algorithm, and Kaliski's Algorithm, the outputs of the Blend Algorithm, B and K, are further processed (mod M). B is (exactly) divided by 2ˆ K (mod M) to get the actual reciprocal 1/D.

In each of these Reciprocal/Inverse algorithms, there is a pair of variables initialized to 1 and 0. These variables are combined with each other and manipulated in simple ways, such as adding one to the other, or doubling, or shifting. One of the variables is returned as the value of the reciprocal, or is further processed to compute the reciprocal. In the Almost-Inverse Algorithm and the Blend Algorithm, the variables are B and C.

If these variables are instead initialized to N times the original values, and certain algorithm adjustments are made, the final value of the reciprocal algorithm will be the quotient N/D. This saves the multiplication step after the reciprocal algorithm, when the quotient is needed. In the Almost-Inverse algorithm, initialize B to N and C to 0. (Notice that no actual multiplication by N is required!)

### Adjustments

In the Almost-Inverse algorithm, the variables B and C start small, and are never longer than M, the modulus, or P, the field polynomial. B and C fit in registers sized for M. Moreover, there's a software optimization that takes advantage of the small size of B and C at the start of the algorithm, and their relatively slow increase, while the algorithm variables F and G decrease. This optimization uses fewer instructions to manipulate B and C when they are small. It can also use some of the registers freed by the shrinkage of F and G to accommodate the growth of B and C. The same holds in Kaliski's algorithm, and usually holds in the Blend algorithm. This optimization is reduced or cancelled when the variable B starts out large, as for the Division algorithm. (The optimization is not usually important in hardware.) Some provision must be made for the resulting larger B and C values. The size increase is manifest when B or C is shifted left, and can be apparent when they are added or subtracted. I prefer option 2 below, but which is best will depend on details of the design or application that needs the quotient.

Options for larger B and C:

(1) Resize the registers holding B and C for larger values. Adding length(N) bits, or length(M), is enough. A modular reduction step is used at the end of the algorithm to bring the answer into range, typically 0<=B<M.

(2) Check for overflow of B or C during the course of the algorithm. When this happens, reduce B and C to a smaller value mod M by adding or subtracting a multiple of M, to make B (or C) small enough. “Small Enough” might mean B<M, or a less stringent condition when there's extra room in the register containing B. It's sometimes useful to have a multiple of M handy for easier arithmetic. For example, in the GF[2ˆ N] case, M might have lots of bits ON, but have a multiple M′ with only a few bits ON, and most modular reduction can use M′.

Checking strategies:

(a) After every shift, add, or subtract.

(b) Keep extra room in registers for B,C, and a counter representing “Free Space in B register”. Debit the counter for shifts, adds, etc. When it reaches 0, reduce B and C, or just one that has an estimate of the smaller space value.

(3) Check for overflow. If it happens, switch to a backup method for computing the quotient.

(4) Don't check for overflows. Verify that quotient is correct, and use a backup method when it isn't.

Options 3 & 4 need enough room in the B & C registers to make use of the backup method rare.

Except for option 2 (those versions that maintain B<M and C<M), a modular reduction step is needed at the end of the quotient algorithm to bring the quotient into normal range. This can be combined with the “finishing step” in the Almost-Inverse algorithm, and Kaliski's, and the Blend algorithm.

### Solution of Quadratic Equations

The solution of quadratic equations (QSolve) has important applications in elliptic-curve cryptography. Several fundamental computations include QSolve as an ingredient, and speeding up the computation for QSolve, and/or reducing the size of the required circuit, or reducing the amount of table memory used, are important benefits of the invention. The improvement is described for the Polynomial basis. It is also useful for field/ring representations that include a polynomial basis as a component, such as Field Towers, or mixed representations.

See Mike Rosing's book, Implementing Elliptic Curve Cryptography, for background on finite fields and solving quadratic equations.

In the next section, we'll be working with finite fields of characteristic 2. Usually there's a defining polynomial of degree D;

Poly(u)=uˆ D+ . . . +1

The coefficients are all mod 2, single bit values, either 0 or 1. Poly is usually irreducible (mod 2), although the algorithms given mostly work whether or not Poly is irreducible. If Poly is not irreducible, the resulting structure is a Ring instead of a Field.

Sometimes we want Poly to be a trinomial, uˆ D+uˆ M+1. M is the degree of the middle term. The quantity G=D−M is the GAP between D and M.

Any field element is some polynomial of degree<D.

A=sum a_{—}k uˆ k

with 0<=k<D, and a_k=0 or 1.

Addition, subtraction, multiplication, division, squaring, roots and Q-solve all operate modulo 2 for coefficients, and modulo Poly for terms with degree D or higher.

When working in software, the usual custom is to store the bits of A so that the higher powers of u are towards the “Left” or “High-order” end of the computer words, and the lower powers of u are at the “Right” or “Low-Order” end of the words. The a_{—}0 coefficient (the constant term, if any, of the polynomial) is usually stored in the low-order bit of a word. We will follow this verbal convention here, while recognizing that an implementation might choose to use a different arrangement of bits.

### Quadratic Equations

This section deals with finite fields of characteristic 2, such as GF[2ˆ D]. In these fields, addition is the same as subtraction, and is carried out by xoring the bit representations of the field elements.

The ordinary quadratic formula doesn't work in characteristic 2 fields, because it has a division by 2. Instead, by well-known change of variables, any quadratic equation can be converted to one of two special equations, either Xˆ 2=A or Xˆ 2+X=A. The former is solved by X=sqrt(A), and is computable by well-known methods in characteristic 2 fields. This improvement addresses the second special equation, and methods for solving it. This exact equation, without any required change of variables, arises in elliptic-curve point halving, which is important for public-key cryptography. It also appears in point doubling.

Notation: Q(x) is xˆ 2+x. The inverse function, which solves the quadratic, is QS(A). Q(QS(A))=A, usually, and QS(Q(x))=x, usually.

A is in some finite field, and we would like X to be in the field. However, Q is a 2−>1 map. The two values X and X+1 both map to the same image; Q(X)=Q(X+1). This means that half the possible A values have two solutions, and the other half have no solution. There is a test for whether A has a solution. There's a bit-mask Tm, called the Trace-mask. To test if QS(A) exists, the bit representation of A is Anded with the Trace-mask. If the parity of the conjunction is even (i.e., A & Tm has an even number of 1 bits) then A is solvable, otherwise not. A bit is ON in the trace-mask when the corresponding field element has no quadratic solution. Sometimes the trace-mask has only one or two bits ON, depending on the field representation. If the field degree is odd, than A=1 has no solution, and the matching bit is ON in the mask. In general, as part of setting up for the algorithm, we select some single ON bit in the trace-mask, corresponding to a field element Beta=uˆ J. In odd-degree fields, we use Beta=1 (and J=0.) If a field element A is solvable (QS(A) exists) then A+Beta is not, and vice versa. The sum of solvable elements is solvable; solvable+unsolvable=unsolvable; unsolvable+unsolvable=solvable. We resolve some ambiguities by declaring that the low-bit of QS (which corresponds to field element uˆ 0=1) is always OFF, and need not be represented in any algorithm or circuit. Moreover, we extend QS to be defined for unsolvable A by declaring QS(A)=QS(A+Beta) by fiat. A possible use for the low bit of QS is to say whether Beta is required or not.

A curious property of Q is linearity: Q(A+B)=Q(A)+Q(B). This leads to a *very* curious property of QS: Linearity! In fact, QS(A+B)=QS(A)+QS(B). An important consequence is that QS(A) can be computed by breaking A into bits or bytes, somehow solving QS for the individual pieces, then adding up the piece solutions to get QS(A). One approach is to prepare a table of the solution for each uˆ K. Any field element is the sum of some of the uˆ K, giving a method for QS(any element).

How to prepare the QS table?

If the field degree is odd, then QS(A)=sum of Aˆ 4ˆ K with 0<=K<D/2. (We might clear the low bit of QS(A), or replace it with the “needs Beta” bit.) Q(QS(A))=A or A+1. When A=uˆ K, then A+Q(QS(A))=0 or 1, and this determines bit K in the trace-mask.

[Note that the odd-degree formula for QS(A) is easy to compute with a hardware circuit: square A repeatedly, and accumulate alternate squares.]

If the field degree is even, we must go more work to find QS(uˆ K), but the formula for the trace-mask bit, A+Q(QS(A)), is still valid.

A general method that works for all degrees, both even and odd, is given in Rosing's book. I give a brief outline:

Suppose the field degree is D. Prepare a D×2D bit matrix. There are D rows, of 2D bits. Row K contains the field representation of uˆ K in the right half (a single bit ON, D−1 bits OFF). The left half of row K contains Q(uˆ K). Use elementary row operations (xor rows, exchange rows) to make the left half of the matrix look as close to an identity matrix as possible. We can't quite succeed, since the rows aren't quire linearly independent, but there's only one degenerate row of all 0s. The other rows contain uˆ K or uˆ K+Beta in the left half, and QS(uˆ K) in the right half. The low order bit of QS can be filled with the Beta column from the left half of the matrix.

The basic table of QS(uˆ K) needs D rows of D bits. It requires an average of D/2 lookups and xors of field elements to compute QS(A) for a typical A, which will have an average of D/2 component bits ON.

I present some hardware and software improvements to the basic algorithm. Some reduce the table size, or number of gates required for a QS-circuit. Some increase the table size, but reduce computation time. Some do both, with smaller and faster computation.

In the following, imagine that QSolve(A) is being computed by a generic circuit or computer subroutine. The circuit or subroutine will have an input register A that supplies A, and an output register Z that receives the answer Z=QSolve(A). The circuit/subroutine will process the bits of A singly or in groups, and make changes to Z that depend on the data from A. Z initially starts out as all 0s, and various data is xored into Z. Some of the methods below make modifications to the input register A. Some of the methods also have one or more output-fixup registers Y1, Y2, etc. These are initially all 0s. They accumulate fixups; at the end of the algorithm, any fixups are added to Z. (Recall that addition=subtraction=xor in the characteristic 2 finite fields we are working with.)

One important variation of the invention is to only compute some of the bits of Z with a QSolve circuit. The remaining bits of Z are then recovered from the equation Q(Z)=A. If some of the bits of Z are known, say as “Zknown”, and the others are “Zunknown”, so that Z=Zknown+Zunknown, the Q(Z)=A equation reduces to Q(Zunknown)=A−Q(Zknown). Often the RHS of this equation contains only even powers of u, uˆ 2K, and it can be solved using equation A. Other times, some of the bits in the RHS value can be combined or used individually to determine some bits of Zunknown. These bits are then included in a revised Zknown, and the Q(Zunknown)=A−Q(Zknown) equation is updated. As Zknown is filled in, non-zero bits are gradually removed from the RHS, until it is 0, and then Z=Zknown. This is explained further below.

When this system is used, the computation/circuit/tables used to compute the startup value of Zknown are much smaller than for the straightforward computation of Z.

The most important optimization is based on equation A:

QS(uˆ 2K)=uˆ K+QS(uˆ K). [Equation A]:

This lets us eliminate even powers of u from our QS solution table, eliminating half the rows. In hardware, the equation is easy to implement. When a field element “A” shows up at the input register for the QS circuit, the even numbered bit positions are quickly disposed of. Each uˆ 2K turns on a uˆ K bit in an Output-Fixup register, and also feeds into an updated coefficient for the uˆ K bit in the QS-input register. Working from the high end (K=D−1, D−2, . . . ) the even numbered bits are folded out of the problem in roughly log_{—}2 D gate delays. The odd-numbered bits are solved with the bit-or-byte-at-a-time table-lookup method above (only half as many xors to do) and then the output-fixup register is added (xored) in to create the final answer for QS(A). Software follows the same idea, generally working a word at a time. We work from the high-order end, (K=D−1, D−2, . . . ). The even numbered bits are masked to separate them from the odd bits. This gives a word that appears in binary as 0a0b0c . . . 0z, where a . . . z are the coefficients of the even- degree terms uˆ 2K.

There are simple programming tricks, well known to assembly language programmers, to squeeze out the 0s in a few instructions, giving abc . . . z. The squeezed word is placed in the output-fixup variable, and also xored as a correction into the QS input. We proceed a word at a time, except that the low-order word must be broken into a left-half, and the right half further split, and the right quarter, etc.

The Equation A optimization works for any (characteristic 2) polynomial, whether or not it is a trinomial, and whether or not it is irreducible.

The next set of optimizations are best for Polynomials which are trinomials, uˆ D+uˆ M+1. (This is the field polynomial.)

They are all based on Equation A and Equation B.

uˆ (K+D)=uˆ (K+M)+uˆ K [Equation B]

One software trick, available for any polynomial, is to group bits together and do one lookup in a larger table for several bits. For example, we might group uˆ 23 to uˆ 16 into an 8-bit byte, and have a table with all 256 possible combinations of the QS(uˆ K) values. This uses more memory, since each byte position needs a separate table—QS(uˆ 23 . . . uˆ 16) is mostly unrelated to QS(uˆ 31 . . . uˆ 24). This isn't especially attractive in hardware, because of the memory requirements, but in software, memory is cheap and cycles are dear. Handling 8 bits at a time speeds the program considerably.

Suppose we've applied the optimization for Equation A, and are working on QS of the remaining collection of odd powers uˆ (2K+1). We could use them as is, or even use the squeezing subroutine to make up words of data for the odd powers, and precompute appropriate solution tables. The best scheme is to shift-and-interleave the odd bits from the high words into the spaces from the low words. With this interleaving, the bits in a 32-bit word would represent

| | | | | | | | | | | | | |
|---|---|---|---|---|---|---|---|---|---|---|---|---|
| 31 | 63 | 29 | 61 | 27 | 59 | | 5 | 37 | 3 | 35 | 1 | 33 |
| u | u | u | u | u | u | . . . | u | u | u | u | u | u |

Now we can pick up, say, 8 mbits at a time and look up the solutions in an appropriate precomputed table.

If there's a choice of trinomials available for defining a finite field, it's best if the degree of the middle term, uˆ M, is not close to either end of the range [1, D−1], but is toward the middle, around D/2. Some of the tricks discussed below work better for such M values.

We let G=D−M, the GAP between the high and middle terms of the trinomial.

We need to branch, discussing 3 cases, based on the parity of the polynomial parameters D and M.

### Case 1

When both D and M are odd, we can use Equation C to reduce the number of “hard bits” for QS, those bits needing a lookup table.

$$QS ( u \hat{} K ) = u \hat{} K + u \hat{} ( K - G / 2 ) + QS ( u \hat{} ( K - G / 2 ) ) + QS ( u \hat{} ( 2 K - D ) ) \qquad [ Equation C ]$$

We apply this formula for K in the range D/2<K<D. Working down from K=D−1, we first take care of the single bit uˆ (D−1), then the pair D−2 and D−3, then four, etc. In software, we switch over to processing whole words when possible. The largest block of birs one can handle together is limited by G/2, since bit K affects bit K−G/2, and by D−K, since bit K affects bit 2K−D=K−(K−D). We need a “bit spread” operation to spread out the block of bits abc . . . z, while interleaving 0s to get a0b0c . . . 0z. This can be done in a small number of assembly language instructions, and is a well-known trick, This is used to build the uˆ (2K−D) terms.

After completing this processing, there will be an output-fixup variable built up from the uˆ K and uˆ (K−G/2) terms, and a leftover block of bits for QS. All the leftover bits will have exponent K<D/2. We process the even numbered bits in this set with equation A. When we are done, only the odd numbered bits less<D/2 remain, which is at most D/4 bits. If we are using hardware, this means only D/4 rows are needed in our table. If we are using software, we can interleave the odd bits and process them in groups of 8, or whatever size is convenient, as indicated above.

One additional trick is available to halve the number of bits in a row, at a small time cost. This is most useful in hardware to further reduce table size, but it also works in software. When building the QS( ) table, we can discard the low bits of each row, for terms uˆ K with K<D/2. This makes each row half as long, only about D/2 bits. We use the table as usual, building up QS(A) from the bits in A. The xored answer is the high-half of QS(A), with bits K>D/2, or field elements made from uˆ K with K>D/2. To recover the low half of QS(A), we invoke a trick. Suppose out partial QS(A) is called QSH (for High Half). We subtract Q(QSH) from A, getting A−Q(QSH). This difference (recall subtraction is really xor) will have a QS that consists entirely of low-half bits, uˆ K with K<D/2. We can determine QS(A−Q(QSH)) entirely by applying Equation A repeatedly; about log_{—}2 D steps are enough. When Equation A is finished, there won't be any left-over odd degree bits, and the cumulative output-fixup from Equation A will be exactly the low-half bits of QS(A) that we needed to recover.

The table size with this approach is D/4 rows, with D/2 bits per row. If we fix the finite field polynomial, and hardwire the table as gates, then we only need gates for the ON bits of the table, which is about 50%. (We can arrange for each individual row to have at most half of its bits ON, by complementing the row if necessary. An additional xor bit records if an odd-number of complemented rows are used, and complements the output accordingly.) The total number of xor gates for the hard-bits portion of QS is about Dˆ 2/16 in the fixed-field case, and Dˆ 2/8 for the general field case. Circuit depth (for this portion) can be as little as log_{—}2 (D/2).

### Case 2

D is odd and M is even.

One option for this case is to “Work with 1/u”. We want QS(A), where A is built from uˆ K with 0<=K<D. We change our viewpoint, temporarily, to a 1/u world. Our field polynomial, instead of uˆ D+uˆ M+1, is 1+uˆ −G+uˆ −D, which is (1/u)ˆ D+(1/u)ˆ G+1. The roles of M and G are interchanged. To convert our field element A to this new system, we work with Equation D, which is a variation of Equation B:

uˆ K=uˆ (K−G)+uˆ (K−D) [Equation D]

We apply the Equation for all K>0, working as usual from the high end. In software, it's easy to work a word at a time. When we are done, we have a new field element A′, equal to A, but expressed entirely in non-positive powers of u, from uˆ 0 down to uˆ (D−1). We could now apply the methods of case 1 with variable uˆ −1 taking the role of u; in this viewpoint, the new Mˆ is odd. when we get QS(A′), we convert back to the old viewpoint with non-negative exponents, using Equation E:

uˆ K=uˆ (K+M)+uˆ (K+D) [Equation E]

This time we work up, starting with K=−(D−1) and finishing with K=−1.

An alternative method for handling Case 2 is available, and perhaps easier to understand. Start with the field element A, built from terms uˆ K, 0<=K<D. Apply Equation D to all K>D/2, working from the high end (K=D−1). This will create some negative powers of u, down to −(D−1)/2. Continue processing K's smaller than D/2, alternating between Equation A to eliminate even K, and Equation D to eliminate odd K. This will create further terms uˆ L with negative even exponents L in the range −D/2>L>−D. All positive terms uˆ K with K>0 are eliminated. We have accumulated an output-fixup term from the use of Equation A. Now we use Equation A to process the negative exponent terms, eliminating all the even exponents and leaving odd exponents K in the range 0>=K>−D/2. We also develop another output-fixup term with negative powers of u. We use equation E to convert this term to non-negative powers, and combine it with the first output-fixup term.

We use a table method (similar to the methods above) to compute QS(uˆ K) for K odd in the range 0>=K>−D/2; the hardware table would have about D/4 rows. A software method would probably interleave and group the bits.

To compute the individual values of QS(uˆ K) with K<0, use Equation F:

QS(uˆ K)=QS(uˆ (K+M))+QS(uˆ (K+D)) [Equation F]

The half-row trick from Case 1 also works here: discard the low half of each row, uˆ K with 0<=K<D/2. Compute the high half of the solution, QSH=HighHalf(QS(A)). (A is composed of negative odd powers of u, with exponent range 0 to −(D−1)/2.) Convert A back to non-negative powers of u with Equation E. Subtract Q(QSH) from the converted A, and use Equation A to recover the missing half of QS(A).

Finally, add the various output-fixup terms to QS(A).

### Case 3

D is even and M is odd. G is also odd.

We first consider the subcase with M<=D/2, and G>=M. Suppose “A” is a general field element, a sum of some powers uˆ K with 0<=K<D. We eliminate as many bits as possible from A. Working from high K down, we eliminate bits with K>G. For even K, we use Equation A; for odd K we use Equation G.

QS(uˆ K)=uˆ ((K+G)/2)+QS(uˆ (K−M))+QS(uˆ ((K+G)/2)) [Equation G]

As K approaches G, the odd values must be handled in small pieces, since (K+G)/2 is only slightly smaller than K.

For QS(uˆ G), a separate table row is required.

For K in the range G>K>=D/2, we can use Equation H to eliminate terms.

$$QS ( u \hat{} K ) = u \hat{} K + u \hat{} ( K - D / 2 ) + QS ( u \hat{} ( 2 K - G ) ) + QS ( u \hat{} ( K - D / 2 ) ) \qquad [ Equation H ]$$

When K is near G, we must use short segments of terms, to avoid overlap with uˆ (2K−G), which is only a little less than K.

This removes all terms uˆ K with K>=D/2. Now use Equation A to eliminate even terms, working down from D/2. We are left with terms for odd K<D/2, to which we apply table methods from Case 1.

The other half of Case 3 is when M>D/2, and G<M.

This is treated with the “1/u method” discussed at the start of Case 2.

The methods discussed here for computing QS mostly continue to work when the polynomial P(u) defining the field is not irreducible. An irreducible factor, P′(u), that divides P(u), must be identified. Suppose its degree is D′. The formulas for creating the QS table entries must be adapted. The sum Aˆ (4ˆ K) works when D′ is odd, and runs for 0<=K<D′/2. The QS matrix should be D′×2D′; QS for uˆ K with K>=D′ is computed as QS(uˆ K mod P′). This is important because many potential degrees D for finite fields GF[2ˆ D] do not have irreducible trinomials of degree D. It seems that most, perhaps all, have irreducible polynomials that divide a trinomial of slightly larger degree D*. The latter trinomial can be used as the working modulus for most field operations, with only occasional use of the true field polynomial with degree D.

Another option is to use pentanomials when trinomials are inconvenient or unavailable. The equations can be altered to include the additional terms. Usually the results are less efficient than the trinomial situation.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes which come within the meaning and range of equivalency of subsequent claims are to be embraced within their scope.

1. Division
In any circuit or computer program for computing reciprocals in a mathematical system such as a finite field or ring or modular arithmetic system,
where the reciprocal is built up as a linear combination of two or more working variables or registers that are initialized at the start of the computation, and where the building up is a sequence of operations chosen from
shifting a variable,
adding one variable to another,
subtracting one variable from another,
negating a variable,
adding or subtracting a multiple of one variable to or from another,
exchanging variables,
permuting variables,
or renaming variables;
I claim the corresponding method or circuit for computing a quotient of two quantities, a numerator and a denominator, by initializing said working variables or registers, at the start of the computation, to different values, specifically, each working variable or register is initialized to a value equal to the product of the numerator times the corresponding initial value from the reciprocal circuit or program.

2. Quadratic Equations.
I claim any circuit or computer program which solves quadratic equations in a finite field or ring of characteristic 2 of even degree, by adding, subtracting, or xoring selected values from a table, with the selection being determined by examining the coefficients and parameters of the quadratic equation, and quantities derived from the coefficients and parameters, said values being combined together with partial solutions determined by directly examining the coefficients and parameters of the equation and quantities derived from the coefficients and parameters.

3. I claim any method of solving a quadratic equation in a characteristic 2 field or ring that computes some of the solution bits in a first phase, and then fills in the rest of the solution bits in subsequent phases.
